(19) United States
(12) Patent Application Publication
(10) Pub. No.: US 2015/0284903 A1
(43) Pub. Date: Oct. 8, 2015

(54) Stripping Foam Carpet Tile

(71) Applicant: ADHESIVE TECHNOLOGIES, LLC, Sarasota, FL (US)

(72) Inventors: Lawrence J. O'Conner, Chatsworth, GA (US); Timothy A. O'Conner, Dalton, GA (US)

(73) Assignee: ADHESIVE TECHNOLOGIES, LLC, Sarasota, FL (US)

(21) Appl. No.: 14/243,871

(22) Filed: Apr. 2, 2014

(51) Int. Cl. D06N 7/00; B32B 37/12; B32B 38/10; E04F 13/00

(52) U.S. Cl. CPC D06N 7/0089; E04F 13/002; B32B 37/1284; B32B 38/10; B32B 2419/04

(57) ABSTRACT

Foam backed carpet tiles are removed from a supporting floor surface without leaving a residue of foam by providing a flexible thin polyester sheet material with a first adhesive material bonding the bottom surface of the foam layer to the top surface of the sheet material and a second adhesive between the bottom surface of the sheet material and the supporting floor surface. The sheet material is caused to separate from the supporting floor surface when removing the carpet tile by the pulling force being applied also to the polyester sheet which has low stretch less than the carpet itself. Also the first adhesive material provides a greater bond strength between the sheet material and the second layer than a bond strength of the second adhesive material and by causing the structural integrity of the second layer to be greater than the bond strength of the second adhesive material.

This invention relates to a carpet tile of the type having an integral sponge cushion underlay for a floor covering and to a method of easily removing the tile from a supporting floor surface to which it is adhesively bonded.

Carpet tiles are usually securely fastened to a floor in order to minimize safety risks and to extend the life of the tiles. The use of an adhesive to firmly bond tiles to a floor has found widespread acceptance. Such carpet tiles can be easily installed with an adhesive and minimal maintenance is required, since the carpet remains in position even with extended use.

The adhesive must form a sufficient bond between the carpet tile and the floor to withstand the heavy compressive loads and lateral forces frequently encountered. For example, furniture, instruments and rolling machinery in residential, institutional and industrial environments can readily induce movement in a carpet tiles that are not firmly bonded to the floor.

It is proposed to use carpet tiles which include a foam cushion between the carpet layer and the floor to enhance comfort and to extend the life of the carpet. In this arrangement the cushion layer must be glued to the floor with the carpeting or pile layer attached to the cushion layer during manufacture as an integral structure.

As the low cost cushion materials used in making carpet tiles usually have low cohesive strength, when the carpet tile is stripped from the floor for repair or replacement, the foam material, typically polyurethane foam is torn apart by the adhesive and a layer of the foam cushion typically remains bonded to the glue on the floor. Manual removal of the cushion adhering to the floor is difficult and expensive. This is particularly problematic in situations where the carpet tiles are replaced regularly so that the problem of removing the layer of foam before new tiles are laid arises often.

Thus, there exists a need in the art for a tile construction capable of meeting the conflicting requirements of providing the desirable foam underlay while allowing the complete tile to be removed from the floor when lifted for replacement. The cushion material must be capable of being securely bonded to a floor to withstand high compressive loads and lateral forces without detaching from the floor. In addition, the cushion must be easily strippable from the floor when the tile is removed.

### SUMMARY OF THE INVENTION

According to the invention there is provided a method of attaching carpet tiles to and subsequently removing the carpet tiles from a supporting floor surface comprising:

providing a carpet material having a first layer of primary carpet fabric having a plurality of pile forming yarns projecting outwardly therefrom and a second layer of a foamed polymer cushioning material disposed on a side of the first layer opposite the pile forming yarns so as to define a bottom surface of the second layer for application to a supporting floor surface;

the first and second layers being coextensive with overlying side edges along edges of the strip;

providing a flexible sheet material having a top surface and a bottom surface;

applying a first adhesive material between the bottom surface of the second layer and the top surface of the sheet material so as to bond the sheet material to the bottom surface of the second layer;

attaching the bottom surface of the sheet material to the supporting floor surface by a second adhesive therebetween;

and removing the tile from the supporting floor surface by pulling the tile while the sheet material and the attachment of the sheet material to the bottom surface of the second layer prevents any part of the second layer from remaining attached to the supporting floor surface.

Typically the tile is pulled from one corner by initially scraping underneath the sheet material at the corner to lift that one corner and then by grasping the tile by the fingers or a suitable tool to pull upwardly on the tile from that corner to peel it off the floor.

The tile should be pulled while grasping the first and second layers and the sheet so that all are pulled simultaneously. This ensures that the pulling force is applied to the bottom surface of the tile through the sheet material so as to reduce the force on the bottom surface of the foam layer which could cause the foam layer to break up and leave patches or parts on the floor.

Preferably the sheet material has characteristics such that it stretches under load less than the carpet layer itself to ensure that pulling force on the tile is applied to the sheet material.

The sheet material being typically polyester of thickness less than 0.001 inch is arranged so that has very low stretch and high tensile strength.

Preferably the first and second adhesive materials are arranged to provide a greater bond strength of the first adhesive material between the sheet material and the second layer than the bond strength of the second adhesive material between the sheet material and the supporting floor surface.

Preferably the structural integrity of the second layer is arranged to be greater than the bond strength of the second adhesive material bonding the sheet material to the supporting floor surface.

In some cases the first and second adhesive materials are formed of the same adhesive which is typically a hot melt adhesive and the greater bond strength is provided by an increased area of overall coverage of the first material relative to the second material.

However instead or in addition the first adhesive material may have an increased bond strength per unit area than the second adhesive material. That is the second adhesive material may have a reduced bond strength for example by using a commercially available easy release hot-melt material otherwise known as a “removable” PSA has been commercially available for many years. One example of this is shown in U.S. Pat. No. 4,728,572 (Davis) issued Mar. 1 1988 and entitled “REMOVABLE HOT MELT PRESSURE SENSITIVE ADHESIVE”. Products of this type typically comprise a high rubber content with low tackifier content. The above patent provides a removable grade hot melt pressure sensitive adhesive, comprising from about 10% to about 50% by weight of the adhesive of at least one styrene-isoprene-styrene block copolymer having a diblock content of greater than about 50% a melt index of less than about 30 grams/10 minutes; from about 10% to about 40% by weight of the adhesive of at least one tackifying resin having a softening point of less than about 120.degree. C. and from about 10% to about 50% by weight of the adhesive of a liquid plasticizer. The resultant adhesive has 180 degree peel values to stainless steel of less than about 4.0 pounds per linear inch.

Preferably to provide the required level of bond strength and to reduce the volume of adhesive used, the first and second adhesive materials are applied in spaced parallel strips or beads of the material typically hot melt adhesive. That is the beads can be applied by a die having row of release opening which cast a stream of the material as the plastic sheet moves past the row.

This allows the bond strength to be controlled simply by changing or selecting the number of strips of the material to be applied. Thus preferably the number of strips of the first material is greater than the number of strips of the second material. That is the first and second adhesive materials are preferably formed of parallel beads of hot-melt adhesive. The use of beads of the material reduces the total cost of application due to the reduction in the amount used and avoids generating very high bond strengths which can prevent any removal of the tile from the floor surface.

Preferably in the manufacturing process the strips of both adhesive materials are applied to the sheet rather than to the second layer, so that the sheet with the adhesives attached is then laminated to the second layer. However the adhesive can also be applied to the second layer and carried into the lamination process on the second layer. Arrangements using either technique can be constructed in the lamination process.

A release sheet is laminated to the second adhesive which is then removed by the installer when the tiles are laid. This also is preferably laminated firstly to the plastic sheet and then the common structure including the sheet, adhesives and release sheet are carried into a lamination process with the carpet layer.

In a suitable manufacturing process, the carpet material is formed as a strip which is laminated to a strip of the sheet and the release sheet and all components are then subsequently cut transversely at spaced positions to form the tiles containing the carpet material and the sheet.

Typically the second layer is a polyurethane foam but other materials can be used which provide the required cushion effect.

Typically the sheet material is of a plastics material such as polyester but other materials can be used which are sufficiently thin and flexible and can be applied at little cost. The sheet material preferably forms a continuous impervious layer but is arranged to have no effect on the bonding action to the floor or to the cushion effect of the second layer. The sheet material is intended to have no structural effect on the cushion layer and is not required to strengthen or otherwise change the surface of the second layer. The sheet material acts as a carrier of the adhesive materials which can then be tailored to provide the required adhesion characteristics relative to each other and relative to the structural integrity of the foam material of the second layer.

The sheet material should be resistant to damage in the presence of moisture. The sheet material should be as thin and inexpensive as possible.

The sheet material should be suitable that it can be handled in the lamination process in widths of 18 inches to 24 inches.

The tile should be pulled while grasping the first and second layers and the sheet so that all are pulled simultaneously.

The sheet material may have characteristics such that it stretches under load less than the carpet layer itself to ensure that pulling force on the tile during the removal is applied to the sheet material.

Thus a fabric such as a non-woven material or a scrim should not be used since it is too expensive and is less stable. The sheet material should also be thermal resistant be resistant to stretching or damage during application of the holt melt adhesive so that polyurethane is likely to be unsuitable at the temperatures necessary for application of the hot-melt.

For the above reasons the best material currently known is very thin polyester having a thickness preferably less than 0.001 inch and more preferably as thin as 0.0005 inch.

The sheet material is preferably applied when the foam is fully set and cooled. Typically the processes used to manufacture the tiles are carried out at different premises as they use different knowledge and skill sets. Thus the carpet layer is manufactured at one facility, the foam is applied at a second facility and the tiles are cut and laminated at a third facility. Thus the application of the sheet material is carried out in a separate subsequent lamination process and not as part of the application of the foam.

Preferably the sheet material is approximately coextensive with the second layer. In a preferred arrangement the sheet material is a little wider than the second layer and the edgemost strips of adhesive are applied as close to the edge of the second layer as possible so that the edges of the tile are as well attached as possible without the danger of the adhesive migrating to the carpet layer or there being any contact between the second adhesive at the underside of the sheet and the first adhesive on top of the sheet.

According to the invention, there can also be provided a carpet tile comprising:

a first layer of primary carpet fabric having a plurality of pile forming yarns projecting outwardly therefrom;

a second layer of a foamed polymer cushioning material disposed on a side of the first layer opposite the pile forming yarns so as to define a bottom surface of the second layer for application to a supporting floor surface;

the first and second layers being coextensive with overlying side edges defining edges of the carpet tile

a flexible sheet material having a top surface attached by a first adhesive material to the bottom surface of the second layer so as to present a bottom surface of the sheet material away from the second layer;

a second adhesive on the bottom surface of the flexible sheet material;

and a release sheet covering the second adhesive material, the release sheet being arranged to be removed allowing the second adhesive material to be bonded to the supporting floor surface.

### BRIEF DESCRIPTION OF THE DRAWINGS

One embodiment of the invention will now be described in conjunction with the accompanying drawings in which:

FIG. 1 is a cross-sectional view through a carpet tile construction for use in the present invention.

FIG. 2 is a cross-sectional view through the carpet tile construction of FIG. 1 when applied to a support floor.

FIG. 3 is a cross-sectional view through the carpet tile construction of FIG. 1 when being removed from a support floor.

FIG. 4 is a schematic side elevational view of a method for manufacture of the carpet tile of FIG. 1.

FIG. 5 is a cross-sectional view along the lines 5-5 of FIG. 4.

FIG. 6 is a cross-sectional view along the lines 6-6 of FIG. 4.

In the drawings like characters of reference indicate corresponding parts in the different figures.

### DETAILED DESCRIPTION

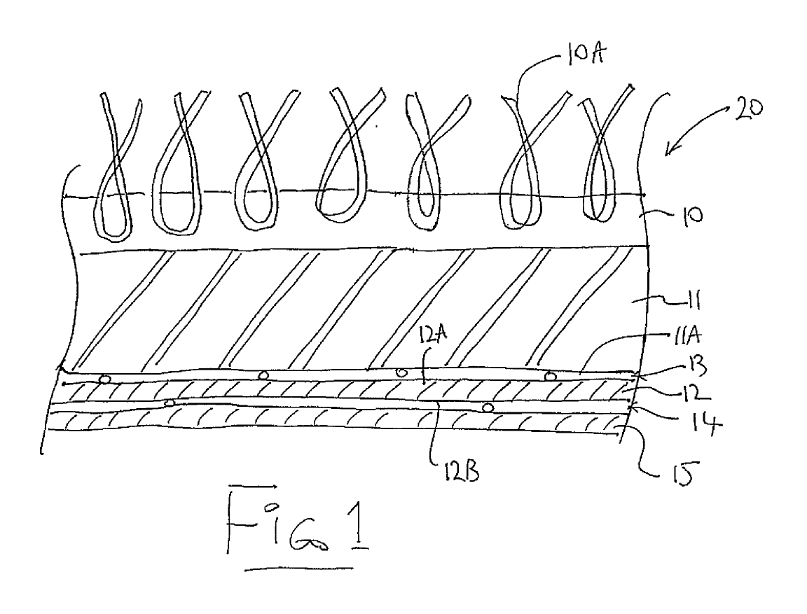

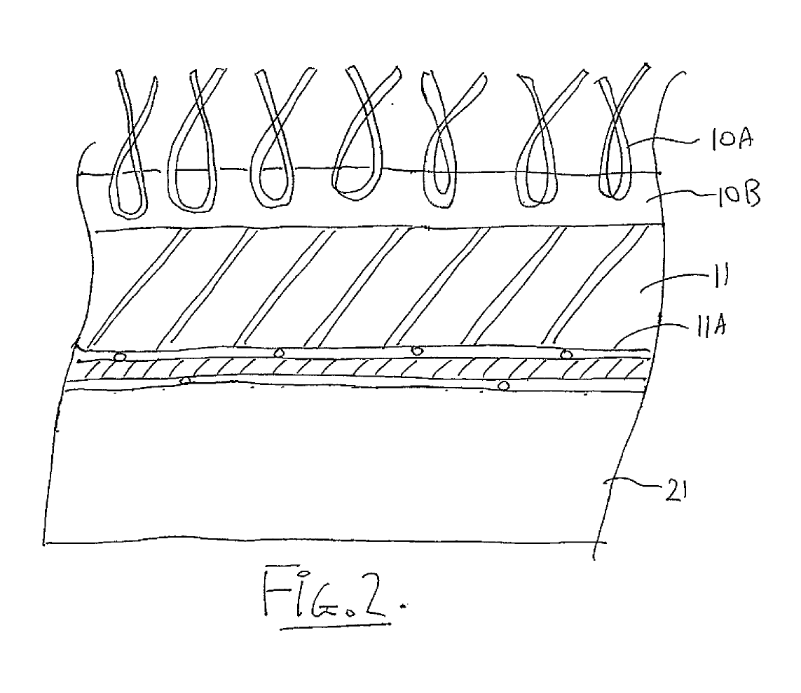

The carpet tile 20 of FIG. 1 includes a first layer 10 of primary carpet fabric having a plurality of pile forming yarns 10A projecting outwardly from a supporting backing material 10B. A second layer 11 of a foamed polymer cushioning material is disposed on or laminated to a side of the first layer 10 opposite the pile forming yarns 10A so as to define a bottom surface 11A of the second layer for application to a supporting floor surface 21. The first and second layers 10, 11 are coextensive with overlying side edges defining edges of the carpet tile 20.

A flexible plastics sheet 12 has a top surface 12A attached by a first adhesive material 13 to the bottom surface 11A of the second layer 11 so as to present a bottom surface 12B of the sheet away from the second layer 11. A second adhesive 14 is provided on the bottom surface of the flexible plastics sheet and covered by a release sheet 15 covering the second adhesive material 14. The release sheet is arranged to be removed allowing the second adhesive material 14 to be bonded to the supporting floor surface 21.

The first adhesive material 13 is arranged to provide a greater bond strength bonding the sheet to the second layer 11 than the bond strength of the second adhesive material 14 bonding the sheet 12 directly to the floor surface 21.

The structural integrity of the second layer 11 is greater than the bond strength of the second adhesive material 14 bonding the sheet 12 to the floor surface 21. In this way when the carpet tile is lifted as shown in FIG. 3 the above relative strengths cause the plastics sheet 12 to separate from the supporting floor surface when removing the carpet tile and to remain as part of the integral structure including the layers 10 and 11 and the sheet 12 so that the tile remains intact and all material is removed from the floor surface leaving it bare.

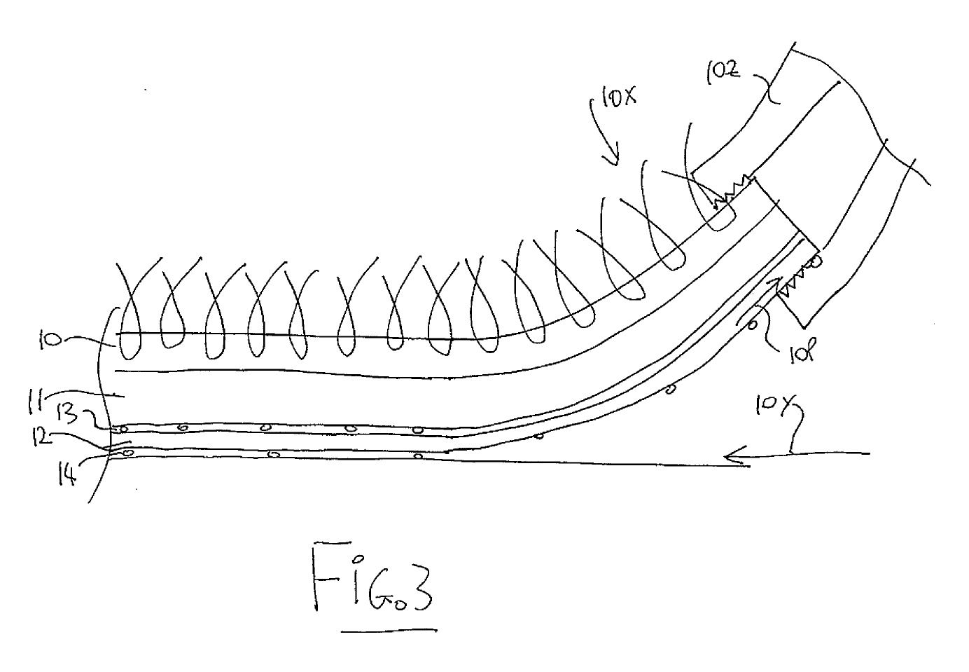

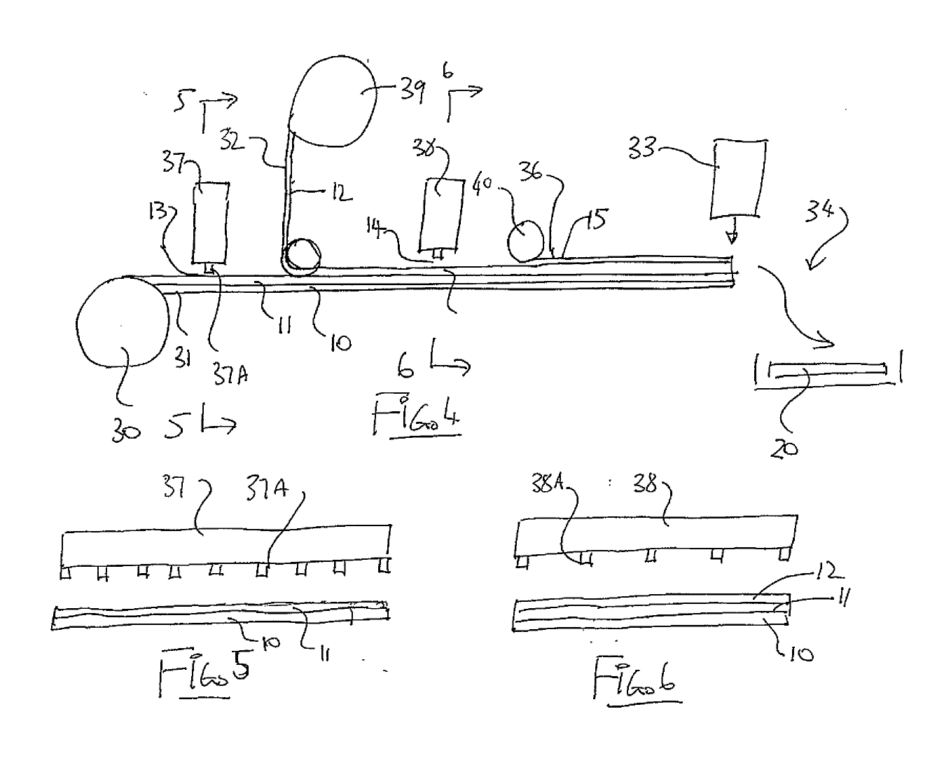

As shown in FIGS. 4 and 5, the tile is constructed by a method where the carpet material is formed initially as a broadloom material containing the first and second layers which is then slit into a strip 31 which is supplied in a roll 30 which is laminated to a strip 32 of the sheet and subsequently cut at a tile cutter 33 transversely at spaced positions to form tiles which are then packaged in a system 34. The strip 32 from a supply 39 of the sheet 12 is laminated to a strip 36 of the release sheet 15 from a supply 40 by the second adhesive 14.

The first and second adhesive materials 13, 14 are applied in spaced parallel strips by a plurality of outlets 37A, 38A of casting dies 37 and 38.

As shown in FIGS. 5 and 6, the number of strips of the first material provided by the outlets 37A is greater than the number of strips of the second material provided by the outlets 38A. As the sheet 12 in the strip 32 is moving forward past the heads, the strips of adhesive are applied as parallel beads of the hot melt adhesive. For convenience, the beads 13 are applied to the second layer 11 which is firstly laminated to the sheet 12 and then laminated to the release sheet 15.

As shown in FIG. 3, a corner of the tile is lifted at 10X by scraping across the floor surface at 10Y and the lifted corner is suitably grasped, which may include a grasping tool such as pliers indicated at 10Z. The pulling force 10P is thus applied through the corner and into to sheet 12 so that the whole of the structure including the sheet 12 is lifted way from the floor.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of attaching carpet tiles to and subsequently removing the carpet tiles from a supporting floor surface comprising:
providing a carpet material having a first layer of primary carpet fabric having a plurality of pile forming yarns projecting outwardly therefrom and a second layer of a foamed polymer cushioning material disposed on a side of the first layer opposite the pile forming yarns so as to define a bottom surface of the second layer for application to a supporting floor surface;
the first and second layers being coextensive with overlying side edges along edges of the strip;
providing a flexible sheet material having a top surface and a bottom surface;
applying a first adhesive material between the bottom surface of the second layer and the top surface of the sheet material so as to bond the sheet material to the bottom surface of the second layer;
attaching the bottom surface of the sheet material to the supporting floor surface by a second adhesive therebetween;
and removing the tile from the supporting floor surface by pulling the tile while the sheet material and the attachment of the sheet material to the bottom surface of the second layer prevents any part of the second layer from remaining attached to the supporting floor surface.

2. The method according to claim 1 wherein the tile is pulled from one corner.

3. The method according to claim 1 wherein the tile is pulled while grasping the first and second layers and the sheet so that all are pulled simultaneously.

4. The method according to claim 1 wherein the sheet material has characteristics such that it stretches under load less than the carpet layer to ensure that pulling force on the tile is applied to the sheet material.

5. The method according to claim 1 wherein the sheet material has high tensile strength so that it has low stretch.

6. The method according to claim 1 wherein the first and second adhesive materials are arranged to provide a greater bond strength of the first adhesive material between the sheet material and the second layer than the bond strength of the second adhesive material between the sheet material and the supporting floor surface.

7. The method according to claim 6 wherein the first and second adhesive materials are formed of the same adhesive and the greater bond strength is provided by an increased area of coverage of the first material relative to the second material.

8. The method according to claim 6 wherein the first adhesive material has an increased bonding strength per unit area than the second adhesive material.

9. The method according to claim 6 wherein the second adhesive material is an easy release hot-melt material.

10. The method according to claim 1 wherein the first and second adhesive materials are applied in spaced parallel strips.

11. The method according to claim 11 wherein the number of strips of the first material is greater than the number of strips of the second material.

12. The method according to claim 1 wherein the strips are applied to the sheet material which is then laminated to the second layer.

13. The method according to claim 1 wherein the carpet material is formed as a strip which is laminated to a strip of the sheet material and to a release sheet covering the second adhesive material and subsequently cut transversely at spaced positions to form tiles.

14. The method according to claim 1 wherein the second layer is urethane foam.

15. The method according to claim 1 wherein the sheet material is polyester.

16. The method according to claim 1 wherein the sheet material forms a continuous impervious layer.

17. The method according to claim 1 wherein the sheet material has a thickness of the order of or less than 0.001 inch.

18. The method according to claim 1 wherein the sheet material is coextensive with the second layer.

19. The method according to claim 1 wherein the first and second adhesive materials are formed of parallel beads of hot-melt adhesive.

20. A carpet tile comprising:
a first layer of primary carpet fabric having a plurality of pile forming yarns projecting outwardly therefrom;
a second layer of a foamed polymer cushioning material disposed on a side of the first layer opposite the pile forming yarns so as to define a bottom surface of the second layer for application to a supporting floor surface;
the first and second layers being coextensive with overlying side edges defining edges of the carpet tile
a flexible sheet material having a top surface attached by a first adhesive material to the bottom surface of the second layer so as to present a bottom surface of the sheet material away from the second layer;
a second adhesive on the bottom surface of the flexible sheet material;
and a release sheet covering the second adhesive material, the release sheet being arranged to be removed allowing the second adhesive material to be bonded to the supporting floor surface.
